(19) United States
(12) Patent Application Publication
(10) Pub. No.: US 2026/0179027 A1
(43) Pub. Date: Jun. 25, 2026

(54) DATA PROCESSING USING SURMISED LANES

(71) Applicant: Private Fleet Net Zero, LLC, San Francisco, CA (US)

(72) Inventors: Russel K Jones, Lafayette, CA (US); Linda Drucker, Lafayette, CA (US)

(21) Appl. No.: 18/988,626

(22) Filed: Dec. 19, 2024

(51) Int. Cl. G06Q 10/083

(52) U.S. Cl. CPC G06Q 10/083

(57) ABSTRACT

The disclosure involves identifying additional paths, called surmised paths, for a transportation service provider's specified path (e.g., backhaul path). A surmised path is a route the provider is willing to service, despite qualifying deviations from the specified path, to reduce empty backhaul load. These paths are derived using matching criteria linked to the specified path, such as having origins or destinations within a specified radius or a specified region (e.g., represented using any shape) of the specified path's locations. Many surmised paths can be generated this way, increasing the likelihood of matching load demands with load capacities. This process not only enhances operational efficiency but also supports environmental decarbonization by optimizing transportation resources.

### TECHNICAL FIELD

The disclosure is related to data processing in the logistics industry, and more specifically, to surmising additional lanes from a carrier lane for increasing matching load availability and load demands. By eliminating empty backhaul loads, the present invention may conserve vehicle fuel, minimize wear and tear on vehicles and roads, require less human capital, decrease traffic congestion, and provide other benefits.

### BACKGROUND

In the realm of transportation logistics, private fleets are often established by a manufacturer, distributor or a retailer with distribution facilities, each establishing a fleet of vehicles, as the private fleet, to meet transportation needs. The private fleet hauls the load of cargo under the control of the private fleet owner from an origin location to a destination location and then returns to the origin location or another location running empty truck, inherently wasting transportation resources and generating needless pollution. Private fleets often provide transportation services on the open market, especially in the backhaul (return trip) capacity to haul the load. Selling this empty capacity increases private fleet profits and also provides a substantial decarbonization of the environment.

Efficient load matching between available load capacities and load demands (e.g., in backhaul) is crucial for optimizing resource utilization and minimizing transportation costs. Traditional methods relied heavily on manual processes (e.g. manually matching) and static data, which often result in suboptimal load matching and underutilization of transportation resources. These methods typically involve human operators manually reviewing available load capacities and matching them with load demands based on predefined routes/paths and schedules. This approach is not only time-consuming but also prone to errors and inefficiencies, particularly in dynamic and complex transportation networks.

To address these challenges, various automated systems have been developed to enhance the load matching process. These systems utilize algorithms to analyze load capacity data and load demand requests, aiming to improve the accuracy and speed of matching. Some approaches involve the use of advanced data analytics and machine learning techniques to predict load demand patterns and optimize load matching. These systems may analyze historical data to identify trends and make predictions about future load demands, which can then be used to adjust load capacity allocations proactively. While these predictive systems offer improvements over traditional methods, they often require significant computational resources and may not fully account for the dynamic nature of transportation networks, where real-time changes in load availability and demand can occur.

Some systems incorporate real-time data feeds from transportation service providers to update load availability and demand information continuously. However, these systems often focus on direct matches between predefined routes and do not account for potential acceptable alternative lanes that could optimize load distribution and resource utilization. None of these approaches have provided a comprehensive solution that combines the features described in this disclosure.

### SUMMARY

The disclosed embodiments are directed to determining additional paths (e.g., surmised paths or lanes) for a provided backhaul path of a transportation service provider. In some embodiments, a surmised path is a path with some qualifying deviations from the provided backhaul path in which a transportation service provider is willing to provide transportation services (e.g., haul the load) for a buyer. This expanded set of available paths facilitates matching with a customer, thus eliminating empty load, potentially increasing profit, and promoting decarbonization.

When a transportation service provider system provides load capacity data for a specified path (e.g., backhaul path), a load matching system may extract origin and destination details from the load capacity data and surmise (e.g., derive) sets of origin or destination locations from the extracted origin and destination details based on matching criteria. For example, a set of origin locations derived from the origin location by determining those locations that are within a specified radius (e.g., based on time or distance) from the origin location of the specified path.

In another example, a set of origin locations are derived from the origin location by determining those locations that are within a specified region (e.g., represented using a geometrical shape, such as a conical shape) from the origin location of the specified path. Similarly, a set of destination locations are derived from the destination location of the specified path. Additional matching criterion may be used in determining the surmised origin or destination locations. In some embodiments, the set of origin locations derived from the origin location of the specified path may be referred to as “a set of surmised origin locations”, and similarly, the set of destination locations derived from the destination location of the specified path may be referred to as “a set of surmised destination locations.”

After the set of surmised origin and destination locations are derived, a set of surmised paths is generated using the set of surmised origin and destination locations. A surmised path may be generated using a pair of origin and destination locations. In some embodiments, a surmised path may be generated using (i) the origin location of the specified path and a location from the set of surmised destination locations, (ii) using a location from the set of surmised origin locations and the destination location of the specified path, or (iii) using a location from the set of surmised origin locations and a location from the set of surmised destination locations.

For example, a first surmised path is generated using the origin location of the specified path and a first surmised destination location from the set of surmised destination locations. In another example, a second surmised path is generated using a first surmised origin location from the set of surmised origin locations and the first surmised destination location. In yet another example, a third surmised path is generated using the first surmised origin location and the destination location of the specified path. Accordingly, for a specified path provided in the load capacity data from the transport service provider, additional paths in which the transport service provider may be willing to provide transport services (e.g., hauling load) may be derived from the specified path.

When a load demand request indicating a demand or need for load capacity along a requested path (also referred to as “load-demand path”) is received, the load matching system may extract path data from the load demand request, and may compare, among other things, the path data of the requested path with that of the specified path or the set of surmised paths to determine a match. Extracted path data may include the information regarding origin location and destination location of the requested path.

In some embodiments, a match is determined when the origin and destination locations of either the specified path or any of the surmised paths match the origin and destination locations of the requested path. After a match is determined, the load matching system may generate a match notification for assigning the load demand request to the load capacity (e.g., by sending a notification to the transport service provider who is providing the transport services along the specified path and to the requestor (e.g., a shipper or broker or buyer) needing the transportation services along the requested path).

By surmising additional paths for a given path (e.g., backhaul path), the load matching system increases the probability of a match between a load demand request and an available load capacity. Further, by increasing the probability of a match between the load demand request and the available load capacity of an empty private fleet backhaul vehicle, the private fleet transport service provider increases revenue. Further, and importantly, environmentally harmful resources that would have otherwise been consumed are reduced, reducing e.g., emissions and aiding environmental decarbonization.

Eliminating empty backhaul loads conserves vehicle fuel, minimizes wear and tear on vehicles and roads, requires less human capital, decreases traffic congestion, and has other benefits.

Various other aspects, features, and advantages of the inventions will be apparent through the detailed description of the invention and the drawings attached hereto. It is also to be understood that both the foregoing general description and the following detailed description are exemplary and not restrictive of the scope of the inventions. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates an environment in which the disclosed embodiments may be implemented, consistent with various embodiments.

FIGS. 2A and 2B are block diagrams for generation of surmised lanes for a specified lane, consistent with various embodiments.

FIG. 3 is a flow diagram of a method for deriving surmised locations from a specified location, consistent with various embodiments.

FIG. 4 is a flow diagram of a method for assigning a load demand request to available load capacity using surmised lanes, consistent with various embodiments.

FIG. 5 is a block diagram of a computer system as may be used to implement features of the disclosed embodiments.

Embodiments are now described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all the described or illustrated elements. Wherever convenient, the same reference numbers are used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

In the following description, for the purposes of explanation, numerous specific details are set forth to provide a thorough understanding of the embodiments of the invention. Those having skill in the art will readily understand that the disclosed embodiments may be practiced without these specific details or with an equivalent arrangement. In other cases, well-known structures and devices are shown in block diagram form to avoid unnecessarily obscuring the disclosed embodiments.

The following describes some terminologies in logistics or transportation services industry. A “shipper” may be anyone, including a broker, who requests transportation services from a transportation services provider (TSP). The shipper may be the entity providing goods needing transport. In the alternative, the shipper may be a party receiving goods and arranging transportation services of the goods. The passenger transportation equivalent would be the passenger, although in some cases, the logistical arrangements are fully made without the direct involvement of the passenger. For purposes of this disclosure, “shipper” is intended to mean anyone who commissions transportation services. If specific categories of transportation are specified, the meaning of “shipper” would be limited as required by the categories.

A transportation service provider or TSP is a business entity that provides transportation (e.g., ground transportation), which includes private fleets. In some cases, the TSP is an independent driver (owner-operator) or similar, whereas in other cases, the TSP performs most of the contract functions in arranging for loads and scheduling. For purposes of the present disclosure and the claims, unless otherwise specified, TSPs comprise companies, mobile operators (MOs) and drivers, as well as independent drivers, with the terms used interchangeably.

Typical shipping is accomplished by directly engaging a transport company, such as a package delivery service, shipping by private fleet controlled by the shipper, brokering services and other transport arrangements. In many cases, the transport is performed on a bid basis, using TSPs such as common carrier haulers.

Private fleets are often established by a manufacturer, distributor or a retailer with distribution facilities, to meet their own transportation needs. Regardless, many private fleets do provide transportation services on the open market, especially in backhaul (return trip) capacity.

Non-limiting examples of transportation services are shipments of loads and related trucking services. Transportation services can include moving passengers, taxi, car services, and so-called “ride sharing” services in which a central business arranges rides for fares, in which case the load can be a passenger or packages. In each of these cases, the transportation service has at least one origin or destination. While “shipper,” “consignor,” “consignee,” “load,” “hauler” and “shipment” are described in connection with transportation services, the descriptions are given by way of non-limiting examples. Transportation services also include providing transportation for items other than loads, so that the “shipper” and “load” may be a passenger or other entity submitting the transportation request, and a “shipment” may be the passenger's trip provided as a transportation service.

In many cases, TSPs use “shipping lanes”, which are origin-destination (consignor-consignee) pairs, generally identified by the general geographical areas of the origin and destination rather than the specific location of the origin or destination. Nevertheless, the “shipping lane” may vary in its specificity, depending on many factors. For example, if a long-distance haul is performed, the TSP may be willing to extend the definition of the shipping lane to cover larger geographic areas for the origin and destination to have an easier time to find a return (backhaul) load.

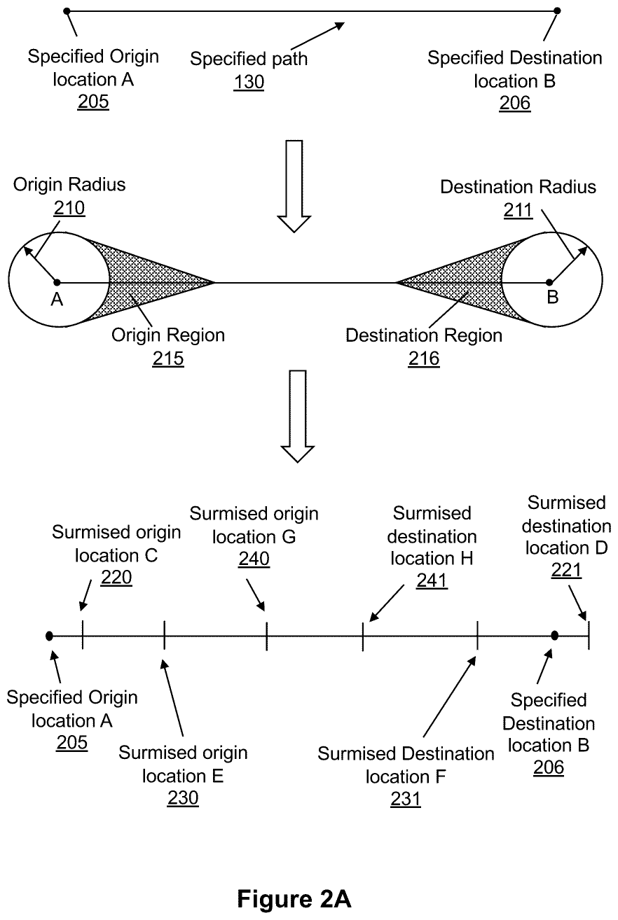

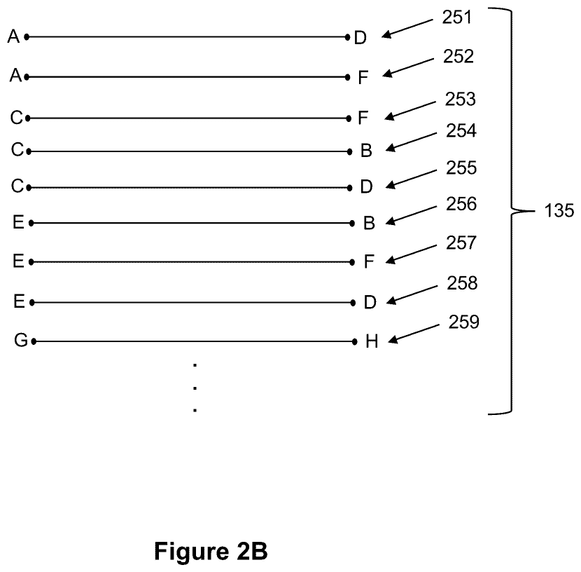

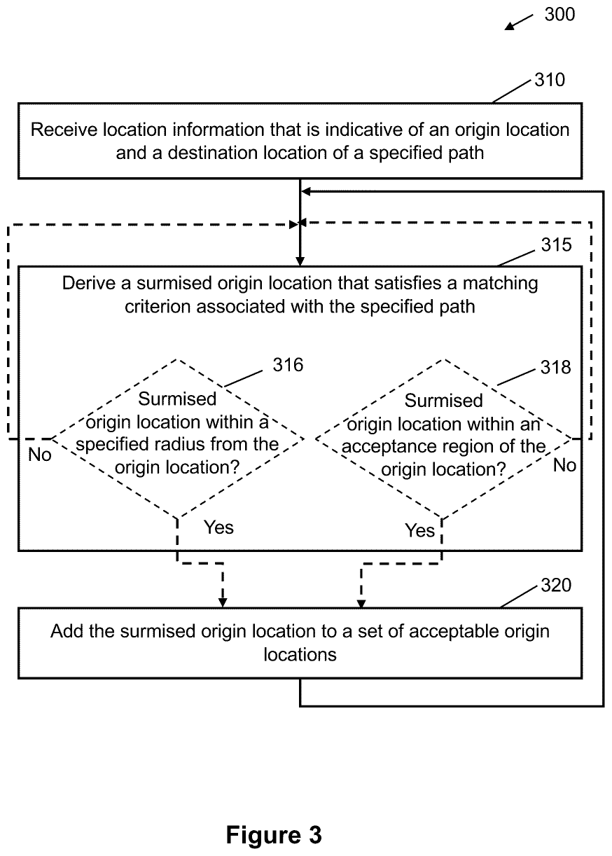

To use a specific non-limiting example, if a TSP is providing services between New York and San Francisco, an origin or destination in Philadelphia may be within the scope of the shipping lane, but over a shorter distance, Philadelphia may be a significant diversion from a shipping lane whose terminus is New York. Various such criteria may be used to determine whether a location (e.g., geographical area) is within the scope of a specified shipping lane, or to surmise additional shipping lanes from a given shipping lane, as described below at least with reference to FIGS. 2 and 3. Note that a shipping lane may also be referred to as “lane,” “shipping path,” “path,” “shipping route”, or “route” and these terms may be used interchangeably.

A “backhaul” may be a return leg in a simple two leg departure-and-return trip. Some trips include more than two legs, in which case a “next leg” or “subsequent leg” generally connects a series of legs back to the origin. Such trips with more than one “backhaul” leg can be more profitable, in that there is often an imbalance of transportation needs in both directions of a shipping lane but are more complicated to arrange because they involve additional arrangements for transportation services and because it is not always apparent how to optimize transportation services bookings. In origin and destination (consignor and consignee) oriented transportation services, it is anticipated that an initial trip will have a subsequent leg. In the case of a simple two-way trip, the single subsequent leg or next leg is a “backhaul”. A “deadhead” leg is a leg without a load, but also describes the connection between different termini while empty or not delivering a load.

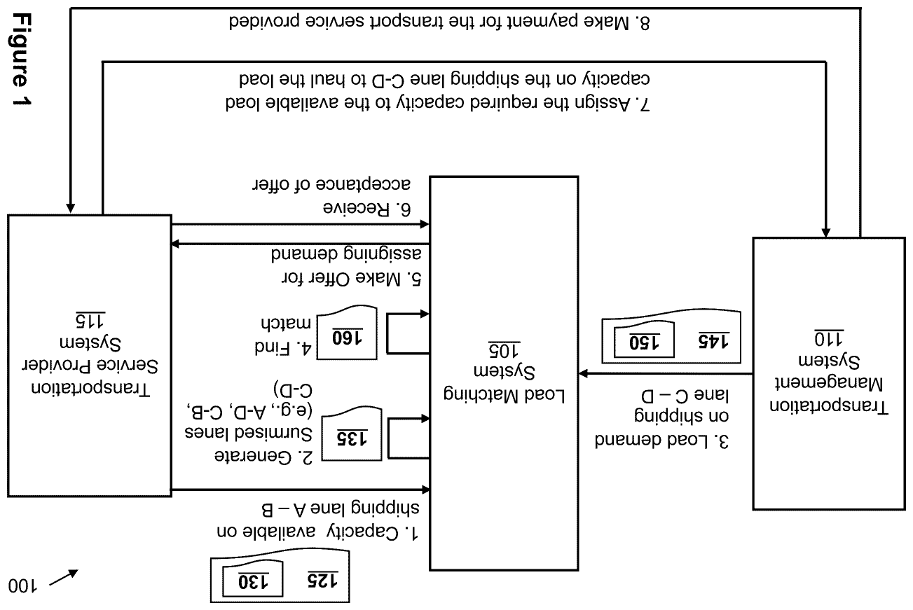

FIG. 1 illustrates an environment 100 in which the disclosed embodiments may be implemented, consistent with various embodiments. Environment 100 includes a transportation service provider (TSP) system 115 that receives load capacity data indicative of available load capacity or other transportation services from a TSP. The load capacity data may include a variety of information.

For example, load capacity data may include specified path or specified lane details such as an origin location and a destination location between which the load capacity is available. The location identifying information of a location such as an origin location or a destination location can be provided in varying degrees of specificity.

For example, the location identifying information can be provided as any of a specific address, a state, a geographical region, a county, a city, a portion of a city, a zip code, etc. The load capacity data may also include information regarding date and time when the load capacity is available. The load capacity data may also include a type of vehicle available, a type of load that can be hauled, TSP identification information (generated by TSP system 115 in some embodiments), or other characteristics of the available transportation service. The load capacity data may be provided in various ways.

For example, the load capacity data may be provided via electronic mail (e-mail), web user interface, EDI, API, mobile communication device app such as a smartphone app, short message service (SMS), voice message, interactive voice response (IVR), telephone communications not using IVR and other suitable interfaces. Such data could be for repetitive or spot load capacity data. The TSP system 115 may include a parsing component that parses the received load capacity data to extract the required attributes, such as origin location and destination location of the specified lane. TSP system 115 may store the load capacity data in a storage system associated with the TSP system 115. The TSP system 115 may store the load capacity in the storage system in a predefined format (e.g., as predefined fields and values).

In some embodiments, the TSP system 115 converts or normalizes the received load capacity data into the predefined format prior to storing the load capacity data in the storage system. In some embodiments, the TSP system 115 may store the load capacity data in both the received format and the predefined format. The TSP system 115 may be associated with one or more TSPs. For example, the TSP system 115 may be associated with a single organization or may be accessible by multiple organizations in which case each of the multiple organizations may input their load capacity availability to the TSP system 115.

Environment 100 includes a transportation management system 110 that receives load demand requests from entities such as shippers. The load demand request may include a variety of information. For example, load demand data may include a requested lane or shipping lane details such as an origin location and a destination location between which the load capacity is needed. The load demand request may also include information regarding date and time when the load capacity is needed. The load demand request may also include a type of vehicle required, a type of load that needs to be hauled, shipper identification information, or other characteristics of the needed transportation service.

Similar to the load capacity data, the load demand data may be provided in various ways. For example, the load demand data may be provided via e-mail, web user interface, EDI, API, mobile communication device app such as a smartphone app, SMS, voice message, IVR, telephone communications not using IVR and other suitable interfaces. The transportation management system 110 may include a parsing component that parses the received load demand request to extract the required attributes, such as origin location and destination location of the requested lane where the load capacity is needed.

The transportation management system 110 may store the load capacity data in a storage system associated with the transportation management system 110. The transportation management system 110 may store the load demand request in the storage system in a predefined format. In some embodiments, the transportation management system 110 converts the received load demand request into the predefined format prior to storing the load demand request in the storage system.

In further embodiments, the transportation management system 110 may store the load demand request in both the received format and the predefined format. The transportation management system 110 may be associated with one or more shippers. For example, the transportation management system 110 may be associated with a single organization or may be accessible by multiple organizations in which case each of the multiple organizations may input their load demand to the transportation management system 110.

The transportation management system 110 and TSP system 115 may be implemented on the same hardware or may be implemented as separate independent hardware systems. In some embodiments, the transportation management system 110 and TSP system 115 are implemented as separate independent systems.

The environment 100 includes a load matching system 105 that is configured to match a load demand request with an available load capacity. The load matching system 105 communicates with both the transportation management system 110 and the TSP system 115 in matching a load demand request with available load capacity. An example of a sequence of interactions between the three entities is illustrated in FIG. 1.

In a first interaction, the load matching system 105 receives load capacity data 125 from a TSP system 115. As mentioned above, the load capacity data 125 may include information regarding a shipping lane 130 or specified path 130 in which the transport services (e.g., load capacity) is provided by the TSP. For example, the load capacity data 125 may indicate that the origin location of the specified lane 130 as “location A” and the destination location of the specified lane 130 as “location B.”

In a second interaction, the load matching system 105 generates a set of surmised lanes 135 for the specified lane A-B. In some embodiments, a set of surmised lanes are lanes in which a TSP is willing to provide transportation services (e.g., haul the load) for a shipper (e.g., to reduce deadheading in the specified lane A-B) although the lane has some deviations from the specified lane A-B. That is, a surmised lane has a different origin-destination pair compared to that of the specified or provided lane.

In further embodiments, the set of surmised lanes are derived from the specified lane A-B, e.g., based on matching criteria associated with specified lane A-B. Various matching criterion may be used in determining surmised lanes for a specified lane. For example, a surmised lane may have at least one of an origin location or a destination location within a specified radius from the origin location or destination location, respectively, of the specified lane A-B. In another example, a surmised lane may have at least one of an origin location or a destination location within a specified region (e.g., represented using a geometrical shape, such as a conical shape) from the origin location or destination location, respectively, of the specified lane A-B. Additional details with respect to determining the surmised lanes are described at least with reference to FIGS. 2 and 3 below.

In the example of FIG. 1, the set of surmised lanes include a first surmised lane A-D (where locations A and D are origin and destination locations of the surmised lane, respectively), a second surmised lane C-B and a third surmised lane C-D and so on. In some embodiments, the surmised lanes are generated to increase the likelihood of finding a matching load demand request for a specified lane.

By increasing the likelihood of matching load demand request with the available load capacity in a specified lane, the revenue opportunities for the TSP are enhanced while reducing resource consumption, such as vehicle fuel wasted on deadheading. Additionally, the fuel that would otherwise be consumed for empty backhaul trips or by another TSP to provide transport services in the backhaul lane is eliminated, thereby significantly lowering emissions and contributing to environmental decarbonization.

In a third interaction, the load matching system 105 may receive a load demand request 145 from the transportation management system 110. The load demand request 145 may include information regarding a requested lane 150 or requested shipping lane 150, such as an origin location and a destination location between which the load capacity is needed by a shipper. For example, the load demand request 145 may indicate that the origin location of the requested lane 150 as location “C” and the destination location of the requested lane 150 as location “D.”

In a fourth interaction, the load matching system 105 may find a matching lane 160 to match the load demand request with the available load capacity. The match may be determined in various ways. For example, the load matching system 105 may compare the requested lane 150 with set of surmised lanes 135 and the specified lane 130 based on the origin and destination locations to identify a matching lane 160.

In some embodiments, any of the surmised lanes 135 or the specified lane 130 having the same origin location and the destination location as the requested lane 150 is determined as a matching lane 160. For example, the fifth surmised lane 255 C-D of the set of surmised lanes 135 matches with the requested lane 150 C-D and is therefore identified as the matching lane 160. Since a matching lane 160 is found, the load matching system may continue with matching the load demand request 145 to the load capacity available on the specified lane 130, or the load matching system may alert TSP of such a match.

Note that, in some embodiments, identifying a matching lane may not be the only criterion for matching a load demand request to an available load capacity and various other criteria may be considered to determine a match. In some embodiments, there may load capacities available from multiple TSPs in a specified lane, or the requested lane 150 may match with surmised lanes of multiple TSPs in which case other criteria may be used in matching the load demand request and available load capacities.

In some embodiments, a load demand is matched to available load capacity in accordance with capabilities and business practices of a TSP providing the transportation services, type of transportation service offered or needed, preference data of the TSP and the shipper, expected price for providing the service, price the shipper is willing to pay for the service, etc. In some embodiments, if there are multiple load demands (e.g., load demand from multiple shippers) for a specified lane, the load matching system 105 may be configured to receive and process bids from the shippers and a winning bid (e.g., highest bid) may be assigned the available capacity.

In some embodiments, if there are multiple load capacities available for a load demand in a requested lane, the load matching system 105 may be configured to receive and process bids from the TSP and a winning bid (e.g., lowest bid) may be assigned to the load demand request. In some embodiments, the load matching system 105 may be implemented using a prediction model, such as a machine learning (ML) model, which is trained to match a load demand request and available load capacity.

The prediction model may consider various factors, such as ML model inferred factors (e.g., user preference data), that may not be explicitly provided by a user (e.g., TSP or shipper). These factors are inferred by the prediction model (e.g., during training or during inference stage) in matching a load demand request and available load capacity. While a prediction model such as a ML model is often suitable, other prediction models such as statistical models or other analytics models may be used in lieu of or in addition to machine learning models.

In a fifth interaction, the load matching system 105 transmits constraint data to the TSP system 115 indicative of constraints (e.g., price) to assign a load demand to the available load capacity on the specified lane A-B.

In a sixth interaction, the load matching system 105 may receive an acceptance, rejection, or a revision (e.g., counteroffer), of the constraint. The sixth interaction may continue until the constraint is rejected, in which case the load demand request is not matched to the available load capacity, or accepted, in which case the load matching system 105 continues to the next interaction to assign the load demand request 145 to the available load capacity on the specified lane A-B.

In a seventh interaction, the load matching system 105 is configured to assign the load demand request 145 to the available load capacity on the specified lane A-B for the provision of the transportation service. In some embodiments, the load matching system 105 sends a notification having the load capacity data 125 to the transportation management system 110, which may further forward the notification to a shipper associated with the load demand request 145. Similarly, the load matching system 105 sends a notification having the load demand request 145 to the TSP system 115, which may further forward the notification to a TSP associated with the load capacity data 125. In some embodiments, the seventh interaction may include other interactions such as price negotiation between the TSP and the shipper for hauling the load. Once the price is agreed upon, the TSP may haul the load for the shipper.

In an eighth interaction, the transportation management system 110 and the TSP system 115 are configured to facilitate the payment from the shipper to the TSP for providing the transportation services (e.g., hauling the load).

Note that this sequence of interactions is just one example sequence, and there can be more interactions, less interactions, or other interactions in matching a load demand request to an available load capacity. Further, note that at least some of the interactions may be executed sequentially, parallelly, simultaneously, synchronously, or asynchronously. For example, while FIG. 1 illustrates the first interaction of receiving the load capacity data 125 and a third interaction of receiving the load demand request 145 are executed sequentially, these two interactions may be independent of each other and may be executed in any order or asynchronously. That is, the load demand request 145 is received first and the load capacity data 125 received later.

In some embodiments, both data is stored in the storage system associated with the load matching system 105 (e.g., as and when they are received) and a matching of the load demand request to the available load capacity is performed when both the data is available. Additionally, in some embodiments, data such as load capacity data 125 or the load demand data 145 may be input to the load matching system 105 directly (e.g., by a user without the use of TSP system 115 or transportation management system 110).

For example, the load capacity data may be input to the load matching system (e.g., by a TSP) via e-mail, web user interface, mobile communication device app such as a smartphone app, SMS, voice message, IVR, telephone communications not using IVR and other suitable interfaces. The load matching system 105 may include a parsing component that parses the received load capacity data to extract the required attributes, such as the origin and destination locations of the specified lane where the load capacity is available.

FIGS. 2A and 2B are block diagrams for generation of surmised lanes for a specified lane, consistent with various embodiments. The specified lane 130 has a specified origin location A 205 (also referred to as origin location A 205) and a specified destination location B 206 (also referred to as destination location B 206). In some embodiments, the specified lane 130 may be provided as an input (e.g., by a user such as a TSP). As discussed at least with reference to FIG. 1, a surmised lane for a specified lane 130 is a lane with some qualifying deviations from the specified lane in which a TSP is willing to provide transportation services (e.g., haul the load) for a shipper (e.g., to reduce deadheading in the provided lane).

Typically, a surmised lane has at least one of the origin location or the destination location different from the origin location or the destination location of the specified lane, respectively. In some embodiments, a surmised lane is generated from (i) an origin location of the specified lane and a surmised destination location, which is derived from the destination location of the specified lane, or (ii) a surmised origin location, which is derived from the origin location of the specified lane and the destination location of the specified lane. Various matching criterion may be used in determining surmised origin and destination locations.

In some embodiments, a criterion such as a radius associated with an origin location of the specified lane may be used in deriving a surmised origin location. For example, an origin radius 210 associated with the origin location A 205 of the specified lane 130 may be used in surmising (e.g., deriving) another origin location from the origin location A 205.

In some embodiments, a surmised origin location C 220, which is determined to be within the origin radius 210, is surmised from the origin location A 205. Similarly, a surmised destination location D 221, which is determined to be within a destination radius 211, is surmised from the destination location B 206. The radius may be specified using any metric or combination of metrics (e.g., travel time, distance, cost of travel, amount of emissions, etc.). For example, if the origin radius 210 is specified in a metric such as a distance (e.g., “5” miles, “20” miles, “30” miles etc.) and the origin location A is specified as a city, then the surmised origin location C 220 may be any city within the specified origin radius 210 distance from the origin location A 205. In another example, if the destination radius 211 is specified in a metric such as a travel time (e.g., “25” minutes, “40” minutes, “60” minutes, etc.) and the origin location A is specified as a city, then the surmised destination location D 221 may be any city within the specified destination radius 211 travel time from the destination location B 206.

The radius may be specified or determined in several ways. In some embodiments, the radius may be user specified (e.g., by a TSP), or may be automatically determined by the load matching system 105 (e.g., using predictive models or user-specified criterion). For example, the radius may be determined as a fraction, or a specified percentage, of a total distance of the specified lane 130 between the origin location A 205 and the destination location 206. Note that the origin radius 210 and the destination radius 211 may have the same value or different values. Also, note that the origin radius 210 and the destination radius 211 may be specified using the same metric or different metrics.

In some embodiments, a criterion such as a specified region (e.g., geographical region) associated with an origin location of the specified lane may be used in deriving a surmised origin location. The specified region may be represented using any geometrical shape. For example, an origin region 215 associated with the origin location A 205 of the specified lane 130 may be represented as a conical shape and used in surmising (e.g., deriving) another origin location from the origin location A 205. In some embodiments, a surmised origin location E 230, which is determined to be within the origin region 215, is surmised from the origin location A 205. Similarly, a surmised destination location D 221, which is determined to be within a destination region 216, is surmised from destination location B 206.

In some embodiments, the origin region 215, which has a conical shape, is defined such that the origin location A forms a center of the cone's base. The cone has a specified height (e.g., representing distance, travel time or another metric from the origin location A) with the cone's apex located on the specified lane 130 in the direction towards destination location B 206. Similarly, the destination region 216, which has a conical shape, is defined such that the destination location B forms a center of the cone's base. The cone has a specified height (e.g., representing distance, travel time or another metric from the destination location B) with the cone's apex located on the specified lane 130 in the direction towards origin location A 205. While FIG. 2A depicts the specified regions 215 and 216 as conical shapes, they may be defined using any geometrical shape. Also, note that shape and size of the two specified regions 215 and 216 may be the same as or different from each other.

While FIG. 2A illustrates deriving of surmised origin and destination locations from the origin and destination locations of the specified lane 130 using two matching criteria, various such criteria may be used in deriving the surmised locations. For example, surmised origin and destination locations may be derived based on a criterion such as whether they are located on the specified lane 130.

As illustrated in FIG. 2A, an origin location such as G 240, which is determined to be located on the specified lane 130, is considered as a surmised origin location G 240. Similarly, a destination location such as H 241, which is determined to be on the specified lane 130, is considered as a surmised destination location H 241. The specified lane 130 may be interpreted in several ways. For example, the specified lane 130 may be interpreted as a direct route (e.g., as the crow flies) between the origin location A 205 and the destination location B 206. In another example, the specified lane 130 may be interpreted as an actual land route (e.g., roads) connecting the origin location A 205 and the destination location B 206.

After the surmised origin and destination locations are derived, a set of surmised lanes may be generated using the surmised origin and destination locations. As described above, any shipping lane, whether actual or surmised, may be defined using an origin-destination location pair. In some embodiments, a surmised lane is generated by selecting (i) the origin location A 205 of the specified lane 130 as an origin location of the surmised lane, and (ii) any location from a set of surmised destination locations as a destination location of the surmised lane. In some embodiments, a surmised lane is generated by selecting (i) any location from the set of surmised origin locations as an origin location of the surmised lane, and (ii) the destination location B 206 of the specified lane 130 as a destination location of the surmised lane. In some embodiments, a surmised lane is generated by selecting (i) any location from the set of surmised origin locations as an origin location of the surmised lane, and (ii) any location from a set of surmised destination locations as a destination location of the surmised lane.

As illustrated in FIG. 2B, a set of surmised lanes 135 is generated using the surmised origin locations 220, 230, and 240 and surmised destination locations 221, 231 and 241. For example, a first surmised lane 251 is generated using origin location A 205 of the specified lane 130 and the surmised destination location D 221 as its origin-destination location pair. A second surmised lane 252 is generated using the origin location A 205 of the specified lane and surmised destination location F 231 as its origin-destination location pair. A third surmised lane 253 is generated using the surmised origin location C 220 and surmised destination location F 231 as its origin-destination location pair. A fourth surmised lane 254 is generated using the surmised origin location C 220 and destination location B 206 of the specified lane as its origin-destination location pair.

A fifth surmised lane 255, a sixth surmised lane 256, a seventh surmised lane 257, an eighth surmised lane 258, a ninth surmised lane 259 and so on may be defined using the surmised origin and destination locations.

In some embodiments, additional constraints or matching criteria may be defined for generating the surmised lanes. The additional constraint may be defined in terms of a metric (e.g., distance, travel time, travel cost, etc.) indicative of a relationship between the surmised locations and the origin and destination locations of the specified lane. For example, the metric may be distance, and additional constraint may be that a maximum extra distance, which is indicative of a distance a TSP has to travel to cover a surmised lane for providing the transportation services compared to the distance the TSP has to travel on the specified lane (e.g., without having to provide the transportation services on the surmised lane) be less than or equal to a threshold distance. If the maximum extra distance that has to be travelled is less than or equal to the threshold distance, the surmised lane satisfies the additional constraint and therefore, may be generated using the identified surmised origin or destination locations.

On the other hand, if the maximum extra distance is greater than the threshold distance, the surmised lane does not satisfy the additional constraint and therefore, may be excluded from the set of surmised lanes. For example, considering the first surmised lane 251 A-D, to provide transportation services from location A-D and then to return to the destination location B 206 of the specified lane 130, a first distance that a vehicle has to travel is determined as a sum of (a) distance from the origin location A 205 to the surmised destination location D 221, and (b) distance from the surmised destination location D 221 to the destination location B 206 of the specified lane 130.

A second distance, which is indicative of a direct distance between the origin location A 205 and the destination location B 206 of the specified lane 130, is determined as the distance that a vehicle has to travel from location A-B without having to travel to the destination location D 221. If the difference between the first distance and the second distance (e.g., maximum extra distance) does not exceed the threshold distance, the first surmised lane 251 may be generated and included in the set of surmised lanes 135, else the first surmised lane 251 may be excluded from the set of surmised lanes 135. The threshold distance (length) may be user defined or may be determined based on other criteria, e.g., as a percentage of the direct distance between the origin location A 205 and the destination location B 206 of the specified lane 130.

If the metric is travel time, the additional constraint may be that a maximum extra time a TSP has to travel to cover a surmised lane for providing the transportation services compared to the time the TSP has to travel on the specified lane be less than or equal to a threshold time. If the maximum extra time that has to be travelled is less than or equal to the threshold time, the surmised lane satisfies the additional constraint and therefore, may be generated using the identified surmised origin or destination locations. On the other hand, if the maximum extra time is greater than the threshold time, the surmised lane does not satisfy the additional constraint and therefore, may be excluded from the set of surmised lanes.

For example, to provide transportation services on the first surmised lane 251 A-D, a first travelling time, which is a time taken by a vehicle to travel from location A 205 to D 221 and then back to location B 206 is determined as a sum of (a) travelling time from the origin location A 205 to the surmised destination location D 221, and (b) travelling time from the surmised destination location D 221 to the destination location B 206 of the specified lane 130. A second travelling time is a time required for the TSP to travel directly from the origin location A 205 to the destination location B 206 of the specified lane 130 (e.g., without having to travel to the destination location D 221).

If the difference between the first travelling time and the second travelling time (e.g., maximum extra time) does not exceed the threshold time, the first surmised lane 251 may be generated and included in the set of surmised lanes 135, else the first surmised lane 251 may be excluded from the set of surmised lanes 135. The threshold time may be user defined or may be determined based on other criteria, e.g., as a percentage of the time required to travel directly from the origin location A 205 to the destination location B 206 of the specified lane 130.

In yet another example, a constraint such as a minimum distance for providing transport services may be defined for generation of the surmised lanes. Considering a ninth surmised lane G-H between surmised origin location G 240 and surmised destination location H 241, if a minimum travel distance, which is indicative of a distance a TSP has to travel from location G 240 to location H 241 to provide the transport services, is greater than or equal to a threshold minimum distance, then the ninth surmised lane 259 satisfies the constraint and therefore, may be included in the set of surmised lanes 135.

On the other hand, if the minimum travel distance is less than the threshold minimum distance, the ninth surmised lane 259 does not satisfy the constraint and therefore, may be excluded from the set of surmised lanes 135. In some embodiments, the benefit (e.g., decarbonization, revenue for TSP etc.) provided in hauling a load for distances less than the threshold minimum distance is not significant and therefore, surmised lanes not satisfying such a constraint may not be generated (e.g., excluded from the set of surmised lanes 135). While the foregoing paragraphs describe using maximum extra distance and maximum extra as additional constraints in determining the surmised lanes, various such constraints may be defined to generate the set of surmised lanes 135.

FIG. 3 is a flow diagram of a method 300 for deriving surmised locations from a specified location, consistent with various embodiments. The method 300 may be implemented in the environment 100 (e.g., using the load matching system 105) and may be implemented for surmising origin locations, destination locations, or both. However, for the sake of convenience, the method 300 is described with reference to surmising origin locations from a specified lane.

At block 310, location information indicative of an origin location and a destination location of a specified lane is obtained. In some embodiments, the load matching system 105 extracts the location information from the received load capacity data 125. For example, the load matching system 105 extracts location information such as origin location A 205 and a destination location B 206 of a specified lane 130.

At block 315, a surmised origin location is derived from the origin location A 205. In some embodiments, the surmised origin location is derived based on a matching criterion associated with a specified. The method 300 illustrates two such criteria in FIG. 3. In a first example 316, a location in the proximity of the origin location A 205 is obtained and a determination is made whether the obtained location is within a specified radius from the origin location A 205. Based on a determination that the obtained location is within the specified radius from the origin location A 205, at block 320, the obtained location is added as a surmised origin location to a set of acceptable origin locations (also referred to as “a set of surmised origin locations”). Note that, as described at least with reference to FIG. 2, the specified radius may be defined using one or more metrics such as distance, time, cost, additional emissions, etc.

In a second example 318, a location in the proximity of the origin location A 205 is obtained and a determination whether the obtained location is within a specified geographical region from the origin location A 205. The specified geographical region may be represented using a geometrical shape. For example, as illustrated in FIG. 2, the origin region 215 is implemented using a conical shape. Based on a determination that the obtained location is within the specified region from the origin location A 205, at block 320, the obtained location is added as a surmised origin location to the set of surmised origin locations. For example, a surmised origin location E 230, which is determined to be within the origin region 215, is added to the set of surmised origin locations. Note that, as described at least with reference to FIG. 2, the specified region may be represented using any shape.

In some embodiments, the specified region is of a conical shape and may be defined such that the origin location of the specified lane forms a center of a base of the cone, the conical shape has a specified height (e.g., which is indicative of a distance, travel time or other metric from the origin location) with an apex of the conical shape located on the specified lane in a direction towards the destination location of the specified lane.

The above blocks (e.g., blocks 315 and 320) may be executed in a loop until a termination condition is satisfied (e.g., a certain number of locations are added to the set of surmised origin locations). The above method 300 may be executed for surmising destination locations as well. After the set of surmised origin locations and the set of surmised destination locations are generated, a set of surmised lanes may be generated using the set of surmised origin locations and the set of surmised destination locations, as described at least with reference to FIG. 2.

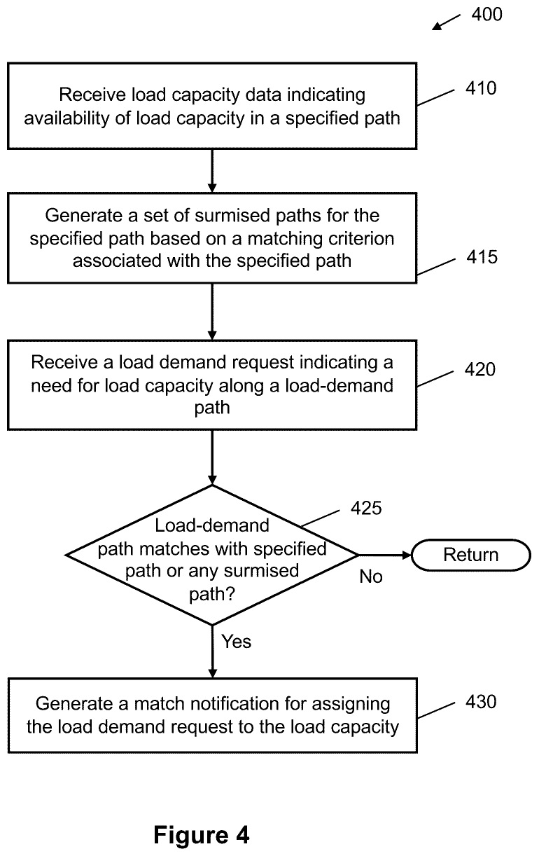

FIG. 4 is a flow diagram of a method 400 for assigning a load demand request to available load capacity using surmised lanes, consistent with various embodiments. The method 400 is implemented in environment 100 of FIG. 1 using the load matching system 105.

At block 410, the load matching system 105 obtains load capacity data indicating availability of load capacity in a specified lane. The load capacity data may be associated with a TSP who provides transportation services, such as hauling a load, in the specified lane. The load matching system 105 may obtain the load capacity data from a TSP system 115 or from a storage system associated with the load matching system 105. The TSP system 115 may store load capacity data associated with multiple TSPs and may be configured to publish this data to the load matching system 105, and such data may be overwritten, modified, and/or be temporary. The specified lane is identified using an origin-destination location pair. For example, the load capacity data indicates availability of load capacity in the specified lane 130.

At block 415, the load matching system generates a set of surmised lanes for the specified lane. In some embodiments, a surmised lane is a lane with some qualifying deviations from the specified lane in which a transportation service provider is or may be willing to provide transportation services (e.g., haul the load) for a shipper (e.g., to reduce deadheading in the provided lane). In some embodiments, the surmised lanes are generated to improve the likelihood of finding a matching load demand request for a specified lane. A surmised lane may be derived from the specified lane 130 by deriving an origin location from the origin location of the specified lane 130 or by deriving a destination location from the destination location of the specified lane 130 based on a matching criterion associated with the specified lane 130.

As described with reference to FIGS. 2 and 3, a set of surmised origin locations is derived from the origin location A 205 of the specified lane 130 by determining those locations that are within a specified radius (e.g., based on at least one of time, distance, cost of travel etc.) from the origin location A 205 of the specified lane 130. For example, a location C that is within the specified radius of the origin location A 205 is derived as the surmised origin location C 220, and similarly, a location D that is within the specified radius of the destination location B 206 of the specified lane 130 is derived as the surmised destination location C 221.

In some embodiments, as described at least with reference to FIGS. 2 and 3, a set of surmised origin locations is derived from the origin location A 205 of the specified lane 130 by determining those locations that are within a specified region (e.g., geographical region represented using a geometrical shape, such as a conical shape) from the origin location A 205 of the specified lane 130. For example, a location E that is within the origin region A 215 is derived as the surmised origin location E 230, and similarly, a location F that is within the destination region 216 is derived as the surmised destination location F 231. Various other criteria may be used in determining the surmised origin locations or the destination locations.

After the set of surmised origin locations and the set of surmised destination locations are determined, a set of surmised lanes may be generated using the set of surmised origin and destination locations. A surmised lane may be generated using a pair of origin and destination locations. In some embodiments, a surmised lane may be generated using (i) the origin location of the specified lane and a location from the set of surmised destination locations, (ii) using a location from the set of surmised origin locations and the destination location of the specified lane, or (iii) using a location from the set of surmised origin locations and a location from the set of surmised destination locations. For example, a first surmised lane 251 is generated using the origin location A 205 of the specified lane 130 and a surmised destination location D 221. In another example, a third surmised lane 253 is generated using a surmised origin location C 220 and a surmised destination location F 231. In yet another example, a fourth surmised lane 254 is generated using the surmised origin location C 220 and the destination location B 206 of the specified lane 130.

Further, as described with reference to FIGS. 2 and 3, additional constraints may be configured or defined in generating the surmised lanes. For example, an additional constraint may be that a maximum extra distance, which is indicative of a distance a TSP has to travel to cover a surmised lane for providing the transportation services compared to the distance the TSP has to travel on the specified lane (e.g., without having to provide the transportation services on the surmised lane) be less than or equal to a threshold distance. If the maximum extra distance is less than or equal to the threshold distance, the surmised lane satisfies the additional constraint and therefore, may be generated using the identified surmised origin or destination locations and added to the set of surmised lanes 135.

On the other hand, if the maximum extra distance is greater than the threshold distance, the surmised lane does not satisfy the additional constraint and therefore may be excluded from the set of surmised lanes 135. Similarly, another constraint such as a minimum distance required for providing transport services in the backhaul may be defined for generation of the surmised lanes. For example, considering a seventh surmised lane E-F between surmised origin location E 230 and surmised destination location F 231, if a minimum travel distance, which is indicative of a distance a TSP has to travel from location E 230 to location F 231 to provide the transport services, is greater than or equal to a threshold minimum distance, then the seventh surmised lane satisfies the constraint and therefore, may be included in the set of surmised lanes 135.

On the other hand, if the minimum travel distance is less than the threshold minimum distance, the seventh surmised lane does not satisfy the constraint and therefore, may be excluded from the set of surmised lanes 135. Various such constraints may be defined for generating the set of surmised lanes 135.

At block 420, the load matching system 105 obtains a load demand request that is indicative of a need for load capacity along a requested lane (load-demand lane). The load matching system 105 may obtain the load demand request from the transportation management system 110 or from a storage system associated with the load matching system 105. The transportation management system 110 may store load demand requests associated with multiple shippers and may be configured to publish this data to the load matching system 105. The requested lane is identified using an origin-destination location pair. For example, the load demand request indicates need for load capacity in the requested lane 150 having origin location C and destination location D.

At determination block 425, a determination is made whether the requested lane matches with the specified lane or any of the specified lanes. A path data of the requested lane 150, that is, the origin-destination pair “C-D”, is compared with the path data of the specified lane 130 or any of the surmised lanes to determine if a matching lane is found. If no match is found, that is, the requested lane 150 does not match with specified lane 130 or any of the surmised lanes 135, the method 400 returns without assigning the load demand request to the compared lanes, and the system may compare additional lanes. If a match is found, that is, the requested lane 150 matches with specified lane 130 or any of the surmised lanes 135, at block 430, the load matching system 105 may generate a match notification for assigning the load demand request to the load capacity, or may generate an offer to the TSP to haul the load to see if the TSP will accept this load. For example, the requested lane 150 C-D matches with the fifth surmised lane 255 C-D of the set of surmised lanes 135.

Accordingly, the load matching system 105 generates a match notification including load capacity data details such as specified lane 130, available load type, vehicle type, date and time of transportation service available, etc. The match notification may further include load demand request details such as requested lane, date and time of transportation service requested, load type, requested vehicle type etc. The load matching system 105 transmits the notification to the transportation management system 110 and the TSP system 115 for provisioning of the transportation service by the TSP to the shipper.

The foregoing embodiments describe matching the load demand request to available load capacity by comparing the requested lane to a specified lane or a set of surmised lanes. That is, in the above embodiments, the matching requires the set of surmised lanes to be generated. However, in some embodiments, the matching may be performed without having to generate the set of surmised lanes, described as follows.

In some embodiments, when the load demand request is received, the load matching system 105 determines whether the requested lane satisfies a matching criterion to be a surmised lane of the specified lane, and based on the determination that the requested lane satisfies the matching criterion to be the surmised lane of the specified lane the load matching system 105 generates a match notification for assigning the load demand request to the load capacity.

Similar to the above embodiments, the load matching system 105 determines the requested lane satisfies the matching criterion to be a surmised lane of the specified lane if the origin location of the requested lane is within (a) a specified radius or (b) a specified region (e.g., represented using a geometrical shape) from the origin location of the specified lane, and if the destination location of the requested lane is within (a) a specified radius or (b) a specified region (e.g., represented using a geometrical shape) from the destination location of the specified lane. Various such criteria may be used to determine whether the requested lane satisfies the matching criterion to be a surmised lane of the specified lane. Accordingly, in such embodiments, while the concept of surmised lanes is used to improve the chances of matching a load demand request and available load capacity, the surmised lanes may not be actually generated for matching a load demand request and available load capacity.

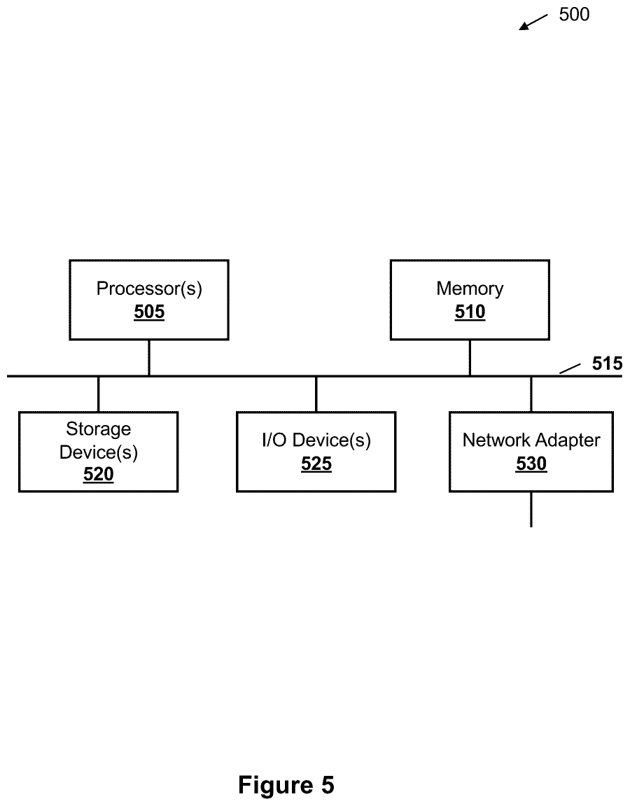

FIG. 5 is a block diagram of a computer system as may be used to implement features of the disclosed embodiments. The computer system 500 may be used to implement any of the entities, systems, subsystems, components or services depicted in the examples of the foregoing figures (and any other components described in this specification). The computer system 500 may include one or more central processing units (“processors”) 505, memory 510, input/output devices 525 (e.g., keyboard and pointing devices, display devices), storage devices 520 (e.g., disk drives), and network adapters 530 (e.g., network interfaces) that are connected to an interconnect 515.

The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Components (IEEE) standard 1394 bus, also called “Firewire”.

The memory 510 and storage devices 520 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non-transitory” media) and computer-readable transmission media.

The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The instructions stored in memory 510 can be implemented as software and/or firmware to program the processor(s) 505 to carry out actions described above. The processors may be programmed to execute computer program instructions by software; hardware; firmware; some combination of software, hardware, or firmware; and/or other mechanisms for configuring processing capabilities on the processors. In some embodiments, such software or firmware may be initially provided to the computer system 500 by downloading from a remote system through the computer system 500 (e.g., via network adapter 530). The systems, such as the load matching system 105, transportation management system 110 and TSP system 115 may be implemented using computer system 500. For example, the computer systems may be implemented by a cloud of computing platforms operating together. The computer systems may enable the exchange of information within a network (e.g., via network adapter 530) or other computing platforms via wired or wireless techniques (e.g., Ethernet, fiber optics, coaxial cable, Wi-Fi, Bluetooth, near field communication, or other technologies).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

1. A method comprising:
receiving, from a transportation service system, load capacity data indicating availability of load capacity in a specified path, wherein the load capacity data includes path data that is indicative of an origin location and a destination location of the specified path;
deriving, at a load matching system, a set of origin locations and a set of destination locations from the origin location and the destination location of the specified path, respectively, based on a matching criterion associated with the specified path, wherein deriving the set of origin locations and the set of destination locations based on the matching criterion includes:
determining a first origin location of the set of origin locations that is within a specified region from the origin location of the specified path, wherein the specified region is indicative of a geographical region in a proximity of the origin location and is represented using a geometrical shape, and
determining a first destination location of the set of destination locations that is within a specified region from the destination location of the specified path, wherein the specified region is indicative of a geographical region in a proximity of the destination location and is represented using a geometrical shape;
generating, at the load matching system, a set of surmised paths for the specified path using the set of origin locations and the set of destination locations, wherein each surmised path of the set of surmised paths is associated with path data that is indicative of an origin location and destination location of the corresponding surmised path,
wherein generating the set of surmised paths includes generating a first surmised path of the set of surmised paths,
wherein the first surmised path is associated with a first path data that is indicative of a first origin location and a first destination location of the first surmised path,
wherein the first surmised path satisfies the matching criterion based on a relationship between the first path data and the path data of the specified path satisfying a metric, wherein the metric is distance,
and wherein the first surmised path satisfies the matching criterion based on a difference between a first distance and a second distance not exceeding a threshold metric;
receiving, from a transportation management system, a load demand request indicating a need for load capacity along a load-demand path, wherein the load demand request includes path data that is indicative of an origin location and a destination location of the load-demand path;
comparing the load-demand path with the set of surmised paths based on the path data of the load-demand path and the path data of any surmised path of the set of surmised paths to determine a match; and
generating a match notification based on the comparing for assigning the load demand request to the load capacity.

2. The method of claim 1, wherein deriving the set of origin locations and the set of destination locations based on the matching criterion includes:
determining a first origin location of the set of origin locations that is within a specified radius from the origin location of the specified path.

3. The method of claim 2, wherein the specified radius is specified using a metric.

4. The method of claim 3, wherein the metric includes at least one of a distance between the origin location and the first origin location, or a time required to travel from the origin location to the first origin location.

5. (canceled)

6. The method of claim 1, wherein the specified region is represented using a conical shape, and wherein the conical shape has a specified height with (a) an apex of the conical shape located on the specified path in a direction towards the destination location, and (b) a center of a base of the conical shape located at the origin location of the specified path.

7. The method of claim 1, wherein deriving the set of origin locations and the set of destination locations based on the matching criterion includes:
determining a first destination location of the set of destination locations that is within a specified radius from the destination location of the specified path.

8. The method of claim 7, wherein the specified radius is specified using a metric.

9. The method of claim 8, wherein the metric includes at least one of a distance between the destination location and the first destination location, or a time required to travel from the first destination location to the destination location.

10. The method of claim 1, wherein deriving the set of origin locations and the set of destination locations based on the matching criterion includes:
the predetermined geometric shapes of the geographical regions in proximity of the origin location and in proximity of the destination location having specified matching criteria within the predetermined geometric shape located on the specified path in a direction towards the origin location.

11. (canceled)

12. The method of claim 1, wherein generating the set of surmised paths includes:
determining a first origin location of the set of origin locations that is within a specified region from the origin location of the specified path but outside of a specified radius from the origin location of the specified path, wherein the specified region is represented using a conical shape, and wherein the conical shape has a specified height with (a) an apex of the conical shape located on the specified path in a direction towards the destination location, and (b) a center of a base of the conical shape located at the origin location of the specified path;
obtaining the destination location of the specified path as a first destination location; and
generating a first surmised path of the set of surmised paths with the first origin location and the first destination location.

13. (canceled)

14. The method of claim 1,
wherein the metric is distance, and wherein:
(a) the first distance is indicative of a distance between the origin location and the destination location of the specified path via the first origin location and the first destination location of the first surmised path, and
(b) the second distance is indicative of a direct distance between the origin location and the destination location of the specified path.

15. The method of claim 14, wherein the threshold metric is determined based on a percentage of the direct distance between the origin location and the destination location of the specified path.

16. The method of claim 14, wherein the first distance is determined based on a sum total of the distance between (a) the origin location of the specified path and the first origin location of the first surmised path, (b) the first origin location and the first destination location of the first surmised path, and (c) the first destination location of the first surmised path and the destination location of the specified path.

17. The method of claim 1, wherein the metric is time, wherein the first surmised path satisfies the matching criterion based on a difference between a first travelling time and a second travelling time not exceeding a threshold metric, and wherein:
(a) the first travelling time is indicative of a time required to travel from the origin location to the destination location of the specified path via the first origin location and the first destination location of the first surmised path, and
(b) the second travelling time is indicative of a time required to travel directly from the origin location to the destination location of the specified path.

18. The method of claim 17, wherein the threshold metric is determined based on a percentage of the time required to travel directly from the origin location to the destination location of the specified path.

19. The method of claim 17, wherein the first travelling time is determined based on a sum total of the time required to travel from (a) the origin location of the specified path to the first origin location of the first surmised path, (b) the first origin location to the first destination location of the first surmised path, and (c) the first destination location of the first surmised path to the destination location of the specified path.

20. A system comprising:
a processor; and
a memory storing instructions that, when executed by the processor, cause the processor to perform a method, the method comprising:
receiving, from a transportation service system, load capacity data indicating availability of load capacity in a specified path, wherein the load capacity data includes path data that is indicative of an origin location and a destination location of the specified path;
deriving, at a load matching system, a set of origin locations and a set of destination locations from the origin location and the destination location of the specified path, respectively, based on a matching criterion associated with the specified path, wherein deriving the set of origin locations and the set of destination locations based on the matching criterion includes:
determining a first origin location of the set of origin locations that is within a specified region from the origin location of the specified path, wherein the specified region is indicative of a geographical region in a proximity of the origin location and is represented using a geometrical shape, and
determining a first destination location of the set of destination locations that is within a specified region from the destination location of the specified path,
wherein the specified region is indicative of a geographical region in a proximity of the destination location and is represented using a geometrical shape;
generating, at the load matching system, a set of surmised paths for the specified path using the set of origin locations and the set of destination locations, wherein each surmised path of the set of surmised paths is associated with path data that is indicative of an origin location and destination location of the corresponding surmised path,
wherein generating the set of surmised paths includes generating a first surmised path of the set of surmised paths,
wherein the first surmised path is associated with a first path data that is indicative of a first origin location and a first destination location of the first surmised path,
wherein the first surmised path satisfies the matching criterion based on a relationship between the first path data and the path data of the specified path satisfying a metric, wherein the metric is distance,
and wherein the first surmised path satisfies the matching criterion based on a difference between a first distance and a second distance not exceeding a threshold metric;
receiving, from a transportation management system, a load demand request indicating a need for load capacity along a load-demand path, wherein the load demand request includes path data that is indicative of an origin location and a destination location of the load-demand path;
comparing the load-demand path with the set of surmised paths based on the path data of the load-demand path and the path data of any surmised path of the set of surmised paths to determine a match; and
generating a match notification based on the comparing for assigning the load demand request to the load capacity.

21. The method of claim 1,
wherein the generating said set of surmised paths comprises:
determining, for the set of origin locations and the set of destination locations, one or more qualifying deviations from a provided backhaul path for providing transportation services, thereby providing an expanded set of surmised paths.

22. The method of claim 21, further comprising:
generating the one or more qualifying examples by selecting, as the one or more qualifying deviations, additional paths according to a determination of which a transport service provider (TSP) with available load capacity may be willing to provide transport services as derived from the specified path.

23. A method comprising:
receiving, from a transportation service system, load capacity data indicating availability of load capacity in a specified path, wherein the load capacity data includes path data that is indicative of an origin location and a destination location of the specified path;
deriving, at a load matching system, a set of origin locations and a set of destination locations from the origin location and the destination location of the specified path, respectively, based on a matching criterion associated with the specified path, wherein deriving the set of origin locations and the set of destination locations based on the matching criterion includes:
determining a first origin location of the set of origin locations that is within a specified region from the origin location of the specified path, wherein the specified region is indicative of a geographical region in a proximity of the origin location and is represented using a geometrical shape, and
determining a first destination location of the set of destination locations that is within a specified region from the destination location of the specified path, wherein the specified region is indicative of a geographical region in a proximity of the destination location and is represented using a geometrical shape;
generating, at the load matching system, a set of surmised paths for the specified path using the set of origin locations and the set of destination locations including one or more qualifying deviations from a provided backhaul path for providing transportation services comprising actual land routes connecting the origin location and the destination location, wherein each surmised path of the set of surmised paths is associated with path data that is indicative of an origin location and destination location of the corresponding surmised path,
wherein generating the set of surmised paths includes generating a first surmised path of the set of surmised paths,
wherein the first surmised path is associated with a first path data that is indicative of a first origin location and a first destination location of the first surmised path,
wherein the first surmised path satisfies the matching criterion based on a relationship between the first path data and the path data of the specified path satisfying a metric, wherein the metric is distance, and wherein the first surmised path satisfies the matching criterion based on a difference between a first distance and a second distance not exceeding a threshold metric;
receiving, from a transportation management system, a load demand request indicating a need for load capacity along a load-demand path, wherein the load demand request includes path data that is indicative of an origin location and a destination location of the load-demand path;
comparing the load-demand path with the set of surmised paths based on the path data of the load-demand path and the path data of any surmised path of the set of surmised paths to determine a match; and
generating a match notification based on the comparing for assigning the load demand request to the load capacity.

24. The method of claim 23, wherein generating the set of surmised paths includes:
determining a first origin location of the set of origin locations that is within a specified region from the origin location of the specified path but outside of a specified radius from the origin location of the specified path, wherein the specified region is represented using a conical shape, and wherein the conical shape has a specified height with (a) an apex of the conical shape located on the specified path in a direction towards the destination location, and (b) a center of a base of the conical shape located at the origin location of the specified path;
obtaining the destination location of the specified path as a first destination location; and
generating a first surmised path of the set of surmised paths with the first origin location and the first destination location.
